(19) United States
(12) Patent Application Publication
(10) Pub. No.: US 2025/0125555 A1
(43) Pub. Date: Apr. 17, 2025

(54) WATERPROOF CONNECTOR

(71) Applicant: GOPOD GROUP HOLDING LIMITED., Shenzhen (CN)

(72) Inventors: Zhuowen LIAO, Shenzhen (CN); Xingwang SONG, Shenzhen (CN); Long MIAO, Shenzhen (CN)

(21) Appl. No.: 18/648,452

(22) Filed: Apr. 28, 2024

Related U.S. Application Data
(63) Continuation of application No. PCT/CN2023/127981, filed on Oct. 30, 2023.

(30) Foreign Application Priority Data
Oct. 13, 2023 (CN) 202322761483.4

(51) Int. Cl. H01R 13/523; H01R 13/66

(52) U.S. Cl. CPC H01R 13/523; H01R 13/6691

(57) ABSTRACT

A waterproof connector, which includes a first component, a second component, and a drainage component. The first component is provided with a first conductive sheet. The second component is butt-connected with the first component and is provided with a second conductive sheet, which contacts with the first conductive sheet. The drainage component is disposed on the first component and corresponds to the position of the first conductive sheet. When using the waterproof connector provided by the present disclosure, the first component and the second component are butt-connected so that the corresponding conductive sheets are in contact with each other, thereby connecting the entire circuit; When water enters the connection between the first component and the second component and the corresponding conductive sheets are about to be submerged, the drainage component can drain the accumulated water in time to avoid short circuit conduction between adjacent conductive sheets.

### CROSS-REFERENCES TO RELATED APPLICATIONS

This disclosure claims priority to the Chinese patent application with application No. 202322761483. 4 and titled “Waterproof Connector” filed with the State Intellectual Property Office of China on Oct. 13, 2023, the entire content of which is incorporated into this disclosure by reference.

### TECHNICAL FIELD

The present disclosure relates to the technical field of electrical connectors, and in particular, to a waterproof connector.

### BACKGROUND OF THE PRESENT INVENTION

In addition to meeting general performance requirements, the most important requirement is that the electrical connector must have good contact, reliable operation, and easy maintenance. Whether its operation is reliable or not directly affects the normal operation of the electrical circuit.

As electrical connectors are used more and more widely, when used outdoors, they are often affected by rain and other complex environments, which can easily cause water to enter or even accumulate at the connection point of the electrical connector, thus the electrical circuit or power supply may be short-circuited and burned during use, posing a safety hazard.

### CONTENTS OF THE PRESENT INVENTION

In view of this, the purpose of the present disclosure is to provide a waterproof connector to overcome the deficiencies in the prior art.

This disclosure provides the following technical solutions:

A waterproof connector includes a first component, a second component and a drainage component.

The first component is provided with a first conductive sheet.

The second component is butt-connected with the first component, and is provided with a second conductive sheet that is in contact with the first conductive sheet.

The drainage component is provided on the first component and corresponds to the position of the first conductive sheet.

There are multiple sets of first conductive sheets and second conductive sheets corresponding to each other.

Further, the drainage component includes a drainage tray, which is installed on the end surface of the first component close to the second component; a drainage hole is provided on the drainage tray, and the first conductive sheet is provided on the first component and penetrates the drainage hole; the end surface of the first component close to the second component is provided with a water channel connected to the drainage hole. The water channel and the drainage tray define a drainage cavity; the side wall of the water channel is provided with a water leakage port, which is connected with the drainage cavity; the first conductive sheet penetrates the drainage cavity and does not contact its inner wall and bottom wall.

Further, the first conductive sheet and the second conductive sheet are both made of elastic metal sheets. The first conductive sheet is fixedly connected to the circuit inside the first component, and the second conductive sheet is fixedly connected to the circuit inside the second component.

Further, a docking groove is provided on the end surface of the drainage tray close to the second component, and the drainage hole is provided on the side wall of the docking groove and close to the bottom of the docking groove.

Further, the drainage tray is provided with a connecting groove on the end surface close to the second component. A connecting ring corresponding to the connecting groove is provided on the end surface of the second component close to the first component and is installed in the connecting groove.

Further, a plurality of first magnets are evenly distributed on the end surface of the connecting groove facing the connecting ring, and the connecting ring is provided with a second magnet which corresponds to the first magnet. The first magnet is magnetically connected to the second magnet.

Further, the first component is provided with a connection through hole on the end surface close to the second component, and the second component is provided with a connecting rod close to the end of the first component. The connecting rod is passed through the connection through hole.

Further, the inner wall of the connection through hole is provided with an arc-shaped protrusion, and the side wall of the connecting rod is provided with an arc-shaped groove. The arc-shaped protrusion is engaged with the arc-shaped groove.

Further, a storage battery is installed in the first component and is connected to the first conductive sheet through a wire.

Further, a display screen connected to the storage battery is provided on the outside of the first component.

Further, an illuminating lamp is provided on the second component and is connected to the second conductive sheet through a wire.

Further, the side surface of the first component is provided with a plurality of tangent planes, wherein two tangent planes are arranged in parallel as a group.

Further, a support component is provided on the side of the first component away from the second component, and the support component includes a support rod, which is connected to the first component. The support rod is provided with a bracket ring, and a plurality of legs is provided on the circumferential side of the bracket.

Embodiments of the present disclosure have the following advantages: When using the waterproof connector provided by the present disclosure, the first component and the second component are butt-connected so that the corresponding conductive sheets are in contact with each other, thereby connecting the entire circuit and making it easy to operate; when water enters the connection between the first component and the second component and the corresponding conductive sheets are about to be submerged, the drainage component provided on the first component can drain the accumulated water in time to avoid short circuit conduction between adjacent conductive sheets, thereby preventing electrical circuits or power supplies from being damaged due to short circuit during use and reducing safety hazards.

In order to make the above-mentioned objects, features and advantages of the present disclosure more obvious and understandable, preferred embodiments are cited below and described in detail with reference to the accompanying drawings.

### DESCRIPTION OF THE DRAWINGS

In order to more clearly illustrate the technical solutions of the embodiments of the present disclosure, the drawings required to be used in the embodiments will be briefly introduced below. It should be understood that the following drawings only show certain embodiments of the present disclosure and therefore should not be regarded as a limitation of the scope. For those of ordinary skill in the art, other relevant drawings can also be obtained based on these drawings without exerting creative efforts.

FIG. 1 shows a schematic structural view of the waterproof connector in an embodiment of the present disclosure;

FIG. 2 shows a schematic structural view of the first component in an embodiment of the present disclosure;

FIG. 3 shows an enlarged structural schematic diagram of position A in FIG. 2;

FIG. 4 shows a schematic structural view of the second component in an embodiment of the present disclosure;

FIG. 5 shows a schematic half-section structural diagram of the first component in an embodiment of the present disclosure;

FIG. 6 shows an enlarged structural schematic diagram of position B in FIG. 5.

### DESCRIPTION OF MAIN COMPONENT SYMBOLS

100—first component; 110—tangent plane; 120—display screen; 130—drainage tray; 131—docking groove; 132—connecting groove; 133—first magnet; 134—drainage hole; 140—first conductive sheet; 150—connection through hole; 151—arc-shaped protrusion; 152—water leakage port; 160—spacer tube; 170—storage battery; 180—water channel; 200—second component; 210—connecting ring; 211—second magnet; 220—illuminating lamp; 230—second conductive sheet; 240—connecting rod; 241—arc-shaped groove; 310—bracket ring; 320—support rod; 330—leg.

### DETAILED DESCRIPTION OF PREFERRED EMBODIMENTS

The present disclosure is described in detail below, examples of which is illustrated in the accompanying drawings; wherein the same or similar reference numerals throughout represent the same or similar elements or elements having the same or similar functions. The embodiments described below with reference to the drawings are exemplary and are only used to explain the present disclosure and are not to be construed as limitations of the present disclosure.

It should be noted that when a component is referred to as being “fixed” to another component, it can be directly on the other component or intervening components may also be present. When a component is said to be “connected” to another component, it can be directly connected to the other component or there may also be intervening components present. In contrast, when a component is referred to as being “directly on” another component, there are no intervening components present. The terms “vertical,” “horizontal,” “left,” “right” and similar expressions are used herein for illustrative purposes only.

In this disclosure, unless otherwise explicitly stated and limited, the terms “installation”, “connection”, “fixing” and other terms should be understood in a broad sense. For example, it can be a fixed connection or a detachable connection, or integrated; it can be a mechanical connection or an electrical connection; it can be a direct connection or an indirect connection through an intermediate medium; it can be an internal connection between two components or an interaction between two components. For those of ordinary skill in the art, the specific meanings of the above terms in this disclosure can be understood according to specific circumstances.

In addition, the terms “first” and “second” are used for descriptive purposes only and cannot be understood as indicating or implying relative importance or implicitly indicating the quantity of indicated technical features. Therefore, features defined as “first” and “second” may explicitly or implicitly include one or more of these features. In the description of the present disclosure, “plurality” means two or more than two, unless otherwise expressly and specifically limited.

Unless otherwise defined, all technical and scientific terms used herein have the same meaning as commonly understood by one of ordinary skill in the art to which this disclosure belongs. The terminology used herein in the description of the templates is for the purpose of describing particular embodiments only and is not intended to limit the disclosure. As used herein, the term “and/or” includes any and all combinations of one or more of the associated listed items.

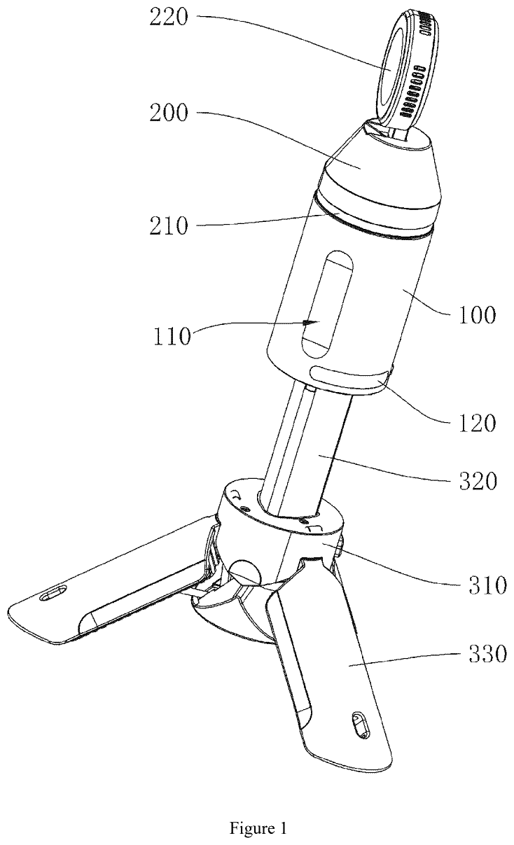

As shown in FIG. 1, an embodiment of the present disclosure provides a waterproof connector, which is mainly used for outdoor electrical connections.

The waterproof connector includes a first component 100, a second component 200, and a drainage component.

Specifically, a first conductive sheet 140 is provided on the first component 100. The second component 200 is butt-connected with the first component 100. The second component 200 is provided with a second conductive sheet 230 that contacts with the first conductive sheet 140. The drainage component (not shown in the figure) is disposed on the first component 100 and corresponds to the position of the first conductive sheet 140.

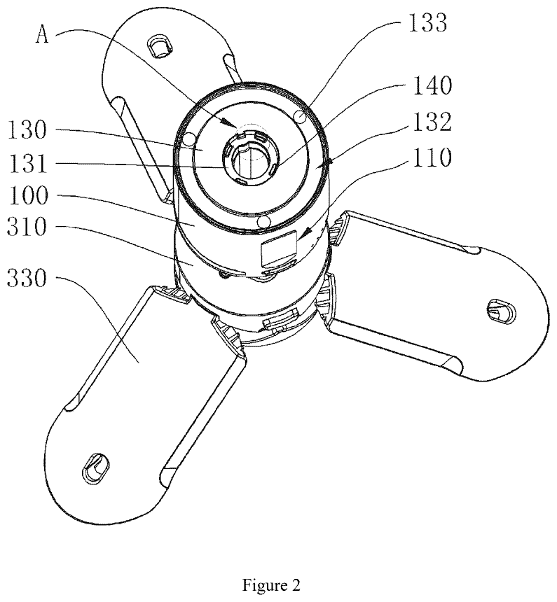

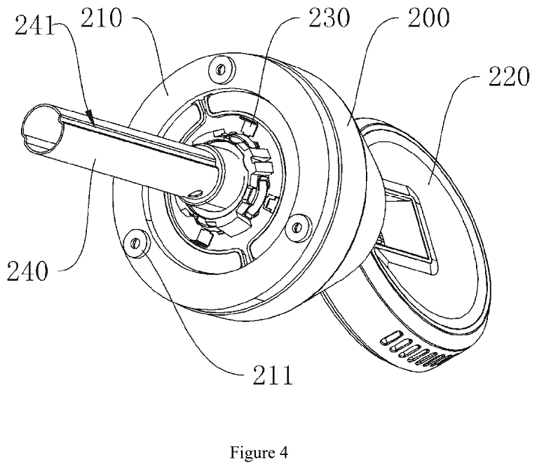

Specifically, as shown in FIGS. 2 and 4, multiple sets of the first conductive sheets 140 and the second conductive sheets 230 are provided correspondingly.

The waterproof connector provided by the embodiment of the present disclosure installs the first conductive sheet 140 and the second conductive sheet 230 that need to be connected on the first component 100 and the second component 200 respectively. Then, by butt-connecting the first component 100 and the second component 200, the first conductive sheet 140 and the second conductive sheet 230 can be brought into contact and connected, that is, the circuit is completed.

At the same time, a drainage component is provided on the first component 100 at a position corresponding to the first conductive sheet 140, that is, a drainage component is provided at the position where the first conductive sheet 140 and the second conductive sheet 230 are connected. When water enters the connection between the first component 100 and the second component 200 and the corresponding conductive sheets are about to be submerged, the accumulated water can be drained out in time to avoid short circuit conduction between adjacent conductive sheets, thereby preventing electrical circuits or power supplies from being damaged due to short circuit during use and reducing safety hazards.

In the above embodiment, the drainage component includes a drainage tray 130, which is installed on the end surface of the first component 100 close to the second component 200.

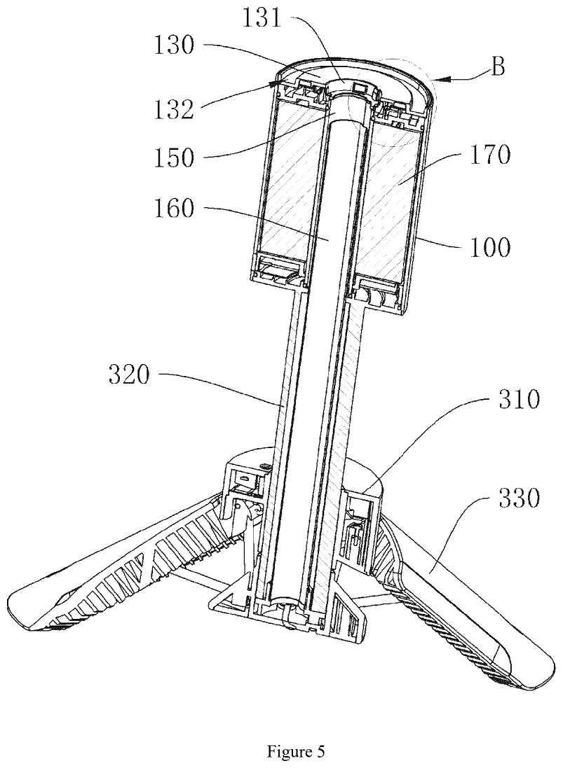

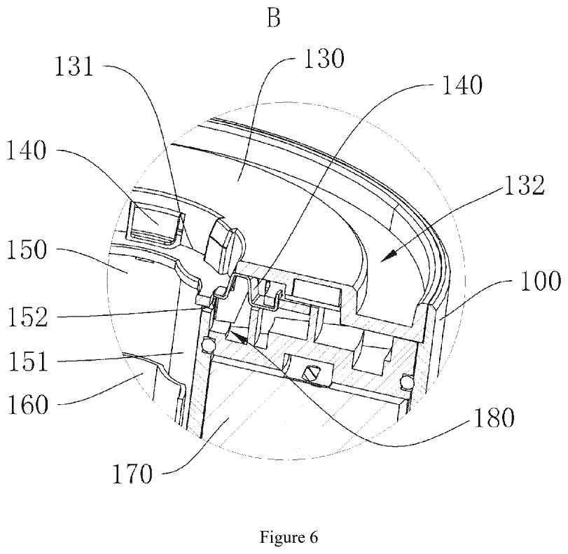

As shown in FIGS. 5 and 6, a drainage hole 134 is provided on the drainage tray 130, and the first conductive sheet 140 is provided on the first component 100 and passes through the drainage hole 134; A water channel 180 connected to the drainage hole 134 is provided on the end surface of one component 100 close to the second component 200. The water channel 180 and the drainage tray 130 define a drainage cavity; a water leakage port 152 is provided on the side wall of the water channel 180 and is connected with the drainage cavity; the first conductive sheet 140 penetrates the drainage cavity and does not contact the inner wall and bottom wall; the above arrangement allows when rainwater enters the connecting surface of the first component 100 and the second component 200, rainwater can quickly enter the drainage cavity through the drainage port, and finally be discharged through the water leakage port 152. During this period, the first conductive sheet 140 maintains a relative distance from the water flow and reduces the probability of short circuit t between adjacent conductive sheets.

As shown in FIG. 6, further, the first conductive sheet 140 and the second conductive sheet 230 are both made of elastic metal sheets, and the first conductive sheets 140 are fixedly connected to the circuits inside the first component 100. The second conductive sheets 230 are fixedly connected to the circuits in the second component 200; due to the good elasticity, the abutment connection between the first conductive sheet 140 and the second conductive sheet 230 is more reliable. Of course, in other embodiments, the first conductive sheet 140 and the second conductive sheet 230 may be rigid metal sheets.

Where, optionally, a docking groove 131 is provided on the end surface of the drainage tray 130 close to the second component 200, and the drainage holes 134 are provided on the side walls of the docking groove 131 and are close to the bottom of the docking groove 131. This provides space for the connection between the first conductive sheet 140 and the second conductive sheet 230 when the first component 100 and the second component 200 are butt connected, thereby preventing the first component 100 and the second component 200 from squeezing the first conductive sheet 140 and the second conductive sheet 230, and improving the connection reliability of this embodiment.

As shown in FIGS. 2 and 4, in some embodiments, the drainage tray 130 is provided with a connecting groove 132 on the end surface close to the second component 200. The end surface of the second component 200 close to the first component 100 is provided with a connecting ring 210 corresponding to the connecting groove 132. The connecting ring 210 is installed in the connecting groove 132; the corresponding cooperation between the connecting ring 210 and the connecting groove 132 facilitates the accurate docking of the first component 100 and the second component 200 and improves the docking and installation efficiency of this embodiment. Of course, in other embodiments, the mating surfaces of the first component 100 and the second component 200 may be provided with square or circular bosses and grooves respectively to improve the mating efficiency.

Further, a plurality of first magnets 133 are evenly distributed on the end surface of the connecting groove 132 toward the connecting ring 210. The connecting ring 210 is provided with second magnets 211 corresponding to the first magnets 133. The first magnet 133 is magnetically connected to the second magnet 211 to improve the docking and installation efficiency of the first component 100 and the second component 200; both the first magnet 133 and the second magnet 211 are strong magnets to improve the connection reliability between the first component 100 and the second component 200. Of course, in other embodiments, the first component 100 and the second component 200 can also be connected through bolts, snaps, or other connection methods.

In the above embodiment, the end surface of the first component 100 close to the second component 200 is provided with a connection through hole 150, and the end surface of the second component 200 close to the first component 100 is provided with a connecting rod 240. The connecting rod 240 is inserted through the connection through hole 150; by inserting the connecting rod 240 into the connection through hole 150, the first component 100 can provide reliable radial support for the second component 200, which facilitates the improvement of the connection reliability between the first conductive sheet 140 and the second conductive sheet 230.

Further, an arc-shaped protrusion 151 is provided on the inner wall of the connection through hole 150, and an arc-shaped groove 241 is provided on the side wall of the connecting rod 240. The arc-shaped protrusion 151 is engaged with the arc-shaped groove 241; it facilitates the accurate docking of the first component 100 and the second component 200, and can effectively prevent the first component 100 and the second component 200 from being connected incorrectly or reversely.

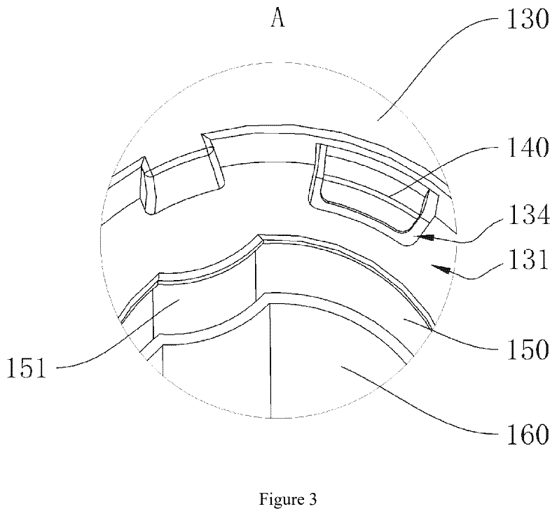

As shown in FIGS. 3 and 5, optionally, a spacer tube 160 with a corresponding shape can also be inserted into the connection through hole 150. The spacer tube 160 can have inner diameters of different sizes to facilitate adaptation to different types of the connecting rod 240 on the second component 200 through the versatility of the present disclosure.

As shown in FIG. 6, in some embodiments, the first component 100 is provided with a storage battery 170, which is connected to the first conductive sheet 140 through wires; the storage battery 170 can provide stable power to the outside through the connection between the first conductive sheet 140 and the second conductive sheet 230.

Specifically, a display screen 120 connected to the storage battery 170 is provided on the outside of the first component 100 to display the remaining power of the storage battery 170.

Further, the second component 200 is provided with an illuminating lamp 220, which is connected to the second conductive sheet 230 through wires. The storage battery 170 can provide stable power to the illuminating lamp 220 through the connection between the first conductive sheet 140 and the second conductive sheet 230, so that the illuminating lamp 220 provides stable lighting.

Specifically, the illuminating lamp 220 is connected to the second component 200 through a lamp pole. Both ends of the lamp pole are hingedly connected to the illuminating lamp 220 and the second component 200 respectively to facilitate adjustment of the lighting direction of the illuminating lamp 220. The illuminating lamp 220 is electrically connected to the second conductive sheet 230 through the lamp pole and the wires provided in the second component 200.

Of course, in other embodiments, the second component 200 is provided with other electrical appliances, which facilitates workers to combine them according to different needs outdoors, thereby improving the functionality of the present disclosure. Furthermore, a second storage battery 170 can be disposed on the second component 200, and a third component or the like can be connected to the second component 200. By connecting multiple storage batteries 170 in series, the battery life of the present disclosure can be improved.

As shown in FIG. 1, in some embodiments, the side surface of the first component 100 is provided with a plurality of tangent planes 110, wherein the two tangent planes 110 are a set of corresponding parallel arrangements, which facilitates storing, stacking o transporting the present disclosure when it is not in use.

Further, a support component is provided on the side of the first component 100 away from the second component 200. The support component includes a support rod 320, which is connected and installed with the first component 100. The support rod 320 has a bracket ring 310 and a plurality of legs 330 are provided on the peripheral side of the bracket ring 310. Each leg 330 is hingedly connected to the bracket ring 310. The connection between each leg 330 and the bracket ring 310 is provided with a maximum opening angle, which is convenient to improve the stable support of the support component to the present disclosure; wherein, the bracket ring 310 is sleeved on the support rod 320, and a locking assembly is provided between the bracket ring 310 and the support rod 320. The relative position of the bracket ring 310 and the support rod 320 is first adjusted and then locked using the locking assembly, so as to facilitate the adjustment of the position of the present disclosure. Of course, in other embodiments, the support component includes a support rod 320, which is provided with two corresponding clamping plates. The two clamping plates are hingedly connected through a shaft, and a torsion spring is provided at the hinge to drive the two clamping plates to clamp, making it convenient to install the disclosure on a wall or other location.

When using the waterproof connector provided by the present disclosure, the first component 100 is placed stably first, and then the second component 200 is connected and installed with the first component 100. During the process of the second component 200 and the first component 100 gradually coming closer to the docking process, the second conductive sheet 230 on the second component 200 gradually approaches its corresponding first conductive sheet 140 and finally abuts to complete a stable connection; when using the present disclosure, especially using outdoors, it is easy to encounter rainy weather. During rain, rainwater can easily enter the joint gap between the first component 100 and the second component 200, and after entering the joint gap, the rainwater will preferentially flow through the drainage hole 134 and enter the drainage cavity formed by the water channel 180 and the drainage tray 130. Finally, it is discharged from the water leakage port 152. As the rainwater entering the joint gap between the first component 100 and the second component 200 is quickly discharged, the accumulation of water near the conductive sheet can be effectively reduced; at the same time, the first conductive sheet 140 is penetrated in the drainage cavity and does not contact with the inner wall and bottom wall of the drainage cavity, which can further reduce the contact between the conductive sheets and rainwater and reduce the risk of short circuit of the conductive sheets.

In all examples shown and described herein, any specific values are to be construed as illustrative only and not as limiting, and accordingly, other examples of the exemplary embodiments may have different values.

It should be noted that similar reference numerals and letters represent similar items in the following figures; therefore, once an item is defined in one figure, it does not need further definition and explanation in subsequent figures.

The above-described embodiments only express several implementation modes of the present disclosure, and their descriptions are relatively specific and detailed, but should not be construed as limiting the scope of the present disclosure. It should be noted that, for those of ordinary skill in the art, several modifications and improvements can be made without departing from the concept of the present disclosure, and these all fall within the protection scope of the present disclosure.

### INDUSTRIAL APPLICABILITY

When using the waterproof connector provided by the present disclosure, the first component and the second component are butt-connected so that the corresponding conductive sheets are in contact with each other, thereby connecting the entire circuit and making it easy to operate; When water enters the connection between the first component and the second component and the corresponding conductive sheets are about to be submerged, the drainage component can drain the accumulated water in time to avoid short circuit conduction between adjacent conductive sheets, thereby preventing electrical circuits or power supplies from being damaged due to short circuit during use and reducing safety hazards.

Furthermore, it will be appreciated that the waterproof connector provided by the present disclosure is reproducible and can be used in a variety of industrial applications. For example, the waterproof connector provided by the present disclosure can be used in the field of electrical connectors.

What is claimed is:

1. A waterproof connector, characterized in that it includes:
A first component, which is provided with a first conductive sheet;
A second component, which is butt-connected with the first component and provided with a second conductive sheet that is in contact with the first conductive sheet;
A drainage component, which is disposed on the first component and corresponds to the position of the first conductive sheet.

2. The waterproof connector according to claim 1, characterized in that the drainage component includes a drainage tray, which is installed on the end surface of the first component close to the second component;
A drainage hole is provided on the drainage tray, and the first conductive sheet is provided on the first component and penetrates the drainage hole;
The end surface of the first component close to the second component is provided with a water channel connected to the drainage hole. The water channel and the drainage tray define a drainage cavity; the side wall of the water channel is provided with a water leakage port, which is connected with the drainage cavity;
The first conductive sheet penetrates the drainage cavity and does not contact its inner wall and bottom wall.

3. The waterproof connector according to claim 2, characterized in that the drainage tray is provided with a docking groove on the end surface close to the second component, and the drainage hole is provided on the side wall of the docking groove and close to the bottom of the docking groove.

4. The waterproof connector according to claim 2, characterized in that the drainage tray is provided with a connecting groove on the end surface close to the second component. A connecting ring corresponding to the connecting groove is provided on the end surface of the second component close to the first component and is installed in the connecting groove.

5. The waterproof connector according to claim 4, characterized in that a plurality of first magnets are evenly distributed on the end surface of the connecting groove facing the connecting ring, and the connecting ring is provided with a second magnet which corresponds to the first magnet. The first magnet is magnetically connected to the second magnet.

6. The waterproof connector according to claim 1, characterized in that the first component is provided with a connection through hole on the end surface close to the second component, and the second component is provided with a connecting rod close to the end of the first component. The connecting rod is passed through the connection through hole.

7. The waterproof connector according to claim 6, characterized in that the inner wall of the connection through hole is provided with an arc-shaped protrusion, and the side wall of the connecting rod is provided with an arc-shaped groove. The arc-shaped protrusion is engaged with the arc-shaped groove.

8. The waterproof connector according to claim 1, characterized in that a storage battery is installed in the first component and is connected to the first conductive sheet through a wire.

9. The waterproof connector according to claim 8, characterized in that an illuminating lamp is provided on the second component, and is connected to the second conductive sheet through a wire.

10. The waterproof connector according to claim 1, characterized in that a support component is provided on the side of the first component away from the second component, and the support component includes a support rod, which is connected to the first component. The support rod is provided with a bracket ring, and a plurality of legs is provided on the circumferential side of the bracket.
